(19) United States
(12) Patent Application Publication
(10) Pub. No.: US 2026/0304235 A1
(43) Pub. Date: Oct. 1, 2026

(54) TAG FOR C-LTM IN SPLIT NODE ARCHITECTURE

(71) Applicant: QUALCOMM Incorporated, San Diego, CA (US)

(72) Inventors: Toru UCHINO, Zushi-shi (JP); Shankar KRISHNAN, Poway, CA (US); Punyaslok PURKAYASTHA, San Diego, CA (US); Doohyun SUNG, Basking Ridge, NJ (US); Prasada Veera Reddy KADIRI, San Diego, CA (US); Jelena DAMNJANOVIC, Del Mar, CA (US)

(21) Appl. No.: 19/538,823

(22) Filed: Feb. 12, 2026

Related U.S. Application Data
(60) Provisional application No. 63/778,265, filed on Mar. 26, 2025.

(51) Int. Cl. H04W 36/00; H04W 56/00; H04W 76/20

(52) U.S. Cl. CPC H04W 36/0016; H04W 36/0058; H04W 36/008355; H04W 56/0045; H04W 76/20

(57) ABSTRACT

Apparatus, methods, and computer program products for wireless communication are provided. An example method may include transmitting, to a candidate network node associated with a user equipment (UE), a preparation request that indicates a set of candidate cells associated with the UE. The example method may further include receiving, from the candidate network node associated with the UE, a preparation response that includes a set of configurations associated with the set of candidate cells associated with the UE. The example method may further include transmitting, to the UE, a RRC message that indicates a mapping between a set of timing advance groups (TAGs) to the set of candidate cells.

### CROSS REFERENCE TO RELATED APPLICATION(S)

The present application for patent claims priority under 35 U.S.C. § 119 to U.S. Provisional Patent Application No. 63/778,265, filed Mar. 26, 2025 and entitled “TAG FOR C-LTM IN SPLIT NODE ARCHITECTURE,” which is assigned to the assignee hereof and is hereby expressly incorporated by reference herein in its entirety.

### TECHNICAL FIELD

The present disclosure relates generally to communication systems, and more particularly, to wireless communication systems with candidate cell timing advance group (C-TAG) management in conditional lower-layer triggered mobility (LTM).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a distributed unit (DU) are provided. The apparatus may include at least one memory and at least one processor coupled to the at least one memory. Based at least in part on information stored in the at least one memory, the at least one processor, individually or in any combination, is configured to (e.g., cause the DU to) receive, from a central unit (CU), a preparation request that indicates a set of candidate cells associated with a user equipment (UE). Based at least in part on information stored in the at least one memory, the at least one processor, individually or in any combination, is configured to transmit, to the CU, a preparation response that indicates a mapping between a set of timing advance groups (TAGs) to the set of candidate cells.

In another aspect of the disclosure, a method, a computer-readable medium, and an apparatus at a CU are provided. The apparatus may include at least one memory and at least one processor coupled to the at least one memory. Based at least in part on information stored in the at least one memory, the at least one processor, individually or in any combination, is configured to transmit, to a candidate network node associated with a UE, a preparation request that indicates a set of candidate cells associated with the UE. Based at least in part on information stored in the at least one memory, the at least one processor, individually or in any combination, is configured to receive, from the candidate network node associated with the UE, a preparation response that includes a set of configurations associated with the set of candidate cells associated with the UE. Based at least in part on information stored in the at least one memory, the at least one processor, individually or in any combination, is configured to transmit, to the UE, a radio resource control (RRC) message that indicates a mapping between a set of TAGs to the set of candidate cells.

In another aspect of the disclosure, a method, a computer-readable medium, and an apparatus at a CU are provided. The apparatus may include at least one memory and at least one processor coupled to the at least one memory. Based at least in part on information stored in the at least one memory, the at least one processor, individually or in any combination, is configured to receive, from a second CU, a preparation request that indicates a set of candidate cells associated with a UE. Based at least in part on information stored in the at least one memory, the at least one processor, individually or in any combination, is configured to transmit, to the second CU, a preparation response that indicates a mapping between a set of TAGs to the set of candidate cells.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating an example of beam management.

FIG. 4B is a diagram illustrating an example of inter-cell beam management.

FIG. 5 is a diagram illustrating an example of cell configuration.

FIG. 6 is a diagram illustrating an example process flow for timing advance groups (TAGs) management in conditional lower-layer triggered mobility (LTM).

FIG. 7 is a diagram illustrating example TAGs.

FIG. 8 is a diagram illustrating example communications between source node(s) including a source central unit (CU) and a source distributed unit (DU), candidate node(s), and a UE.

FIG. 9 is a diagram illustrating example communications between source node(s) including a source CU and a source DU, candidate node(s), and a UE.

FIG. 10 is a diagram illustrating example communications between source node(s) including a source CU and a source DU, candidate node(s) including a candidate CU and a candidate DU, and a UE.

FIG. 11 is a diagram illustrating example communications between source node(s) including a source CU and a source DU, candidate node(s) including a candidate CU and a candidate DU, and a UE.

FIG. 12 is a flowchart of a method of wireless communication.

FIG. 13 is a flowchart of a method of wireless communication.

FIG. 14 is a flowchart of a method of wireless communication.

FIG. 15 is a diagram illustrating an example of a hardware implementation for an example network entity.

FIG. 16 is a diagram illustrating an example of a hardware implementation for a network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Because candidate cells in different distributed unit (DU) or central unit (CU) may be grouped (e.g., if transmission reception points (TRPs) are deployed in the same area, if timing advance (TA) value is deterministic such as zero for small cell, if the UE happen to have an equal distance to different DUs or CUs even if the DUs or the CUS are in different areas), or the like, the timing advance group (TAG) may be determined by one network node accordingly. Example aspects provided herein provide signaling related to scenarios where (1) the source CU (which may also be referred to as an “S-CU”) determines (which may be otherwise referred to as “decide”) the TAG (e.g., and corresponding TA value or time alignment timer value), (2) the source DU (which may also be referred to as an “S-DU”) determines the TAG, (3) a candidate DU (which may also be referred to as a “C-DU”) determines the TAG, or (4) a candidate CU (which may also be referred to as a “C-CU”) determines the TAG.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

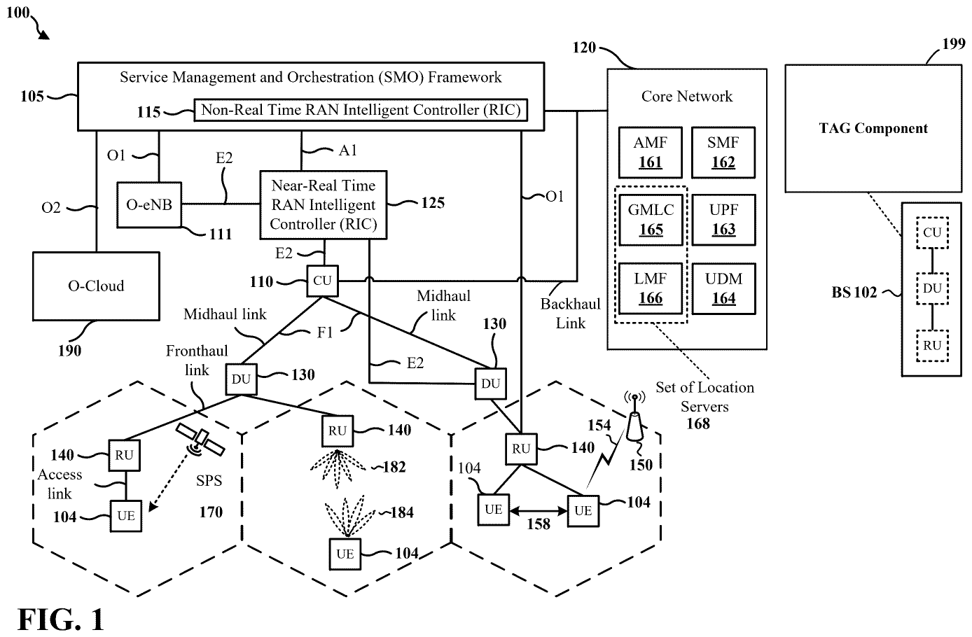

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

In certain aspects, the base station 102 may include a timing advance group (TAG) component 199. In some aspects, the TAG component 199 may be configured to receive, from a CU, a preparation request that indicates a set of candidate cells associated with a UE. In some aspects, the TAG component 199 may be further configured to transmit, to the CU, a preparation response that indicates a mapping between a set of TAGs to the set of candidate cells.

In some aspects, the TAG component 199 may be further configured to transmit, to a candidate network node associated with a UE, a preparation request that indicates a set of candidate cells associated with the UE. In some aspects, the TAG component 199 may be further configured to receive, from the candidate network node associated with the UE, a preparation response that includes a set of configurations associated with the set of candidate cells associated with the UE. In some aspects, the TAG component 199 may be further configured to transmit, to the UE, a RRC message that indicates a mapping between a set of TAGs to the set of candidate cells.

In some aspects, the TAG component 199 may be further configured to receive, from a second CU, a preparation request that indicates a set of candidate cells associated with a UE. In some aspects, the TAG component 199 may be further configured to transmit, to the second CU, a preparation response that indicates a mapping between a set of TAGs to the set of candidate cells.

Although the following description may be focused on 5G NR, the concepts described herein may be applicable to other similar areas, such as 6G, LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

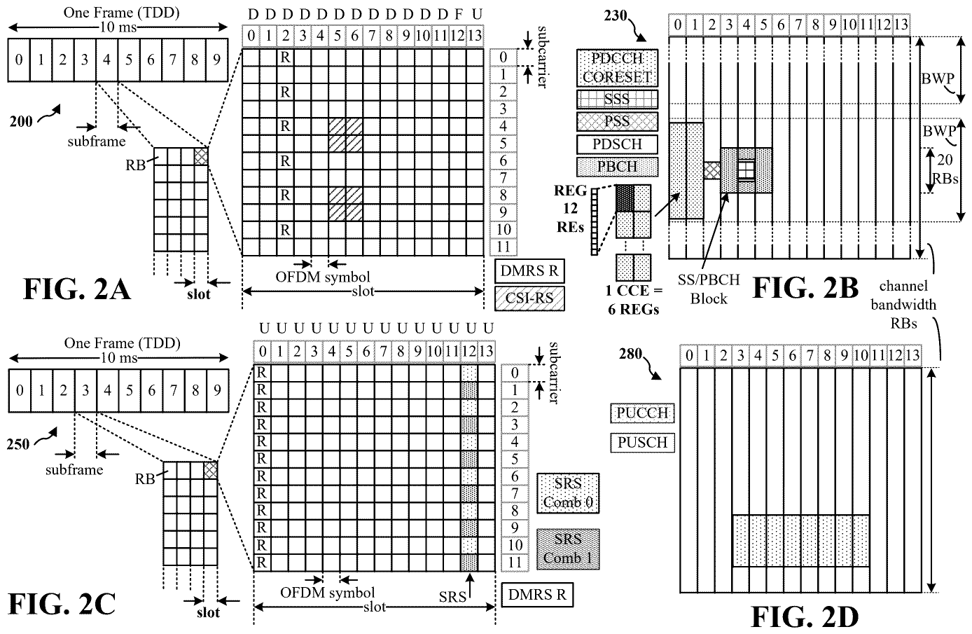

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

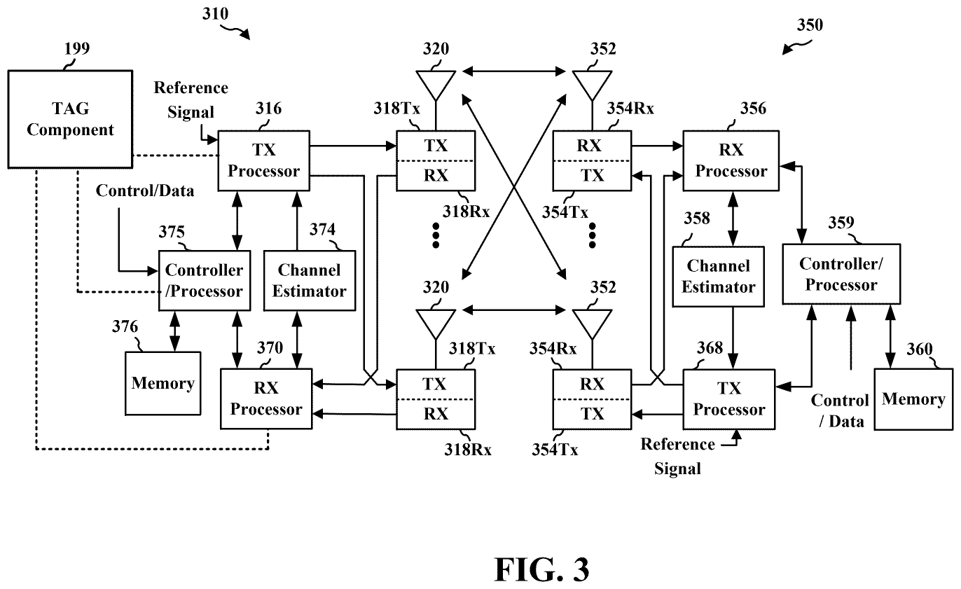

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 316, the RX processor 370, and the controller/processor 375 may be configured to perform aspects in connection with TAG component 199 of FIG. 1.

A network may be in communication with a UE based on one or more beams (spatial filters). For example, a base station of the network may transmit a beamformed signal to a UE in one or more directions that correspond with one or more beams. The base station and the UE may perform beam training to determine the best receive and transmit beam directions for the base station and the UE.

In response to different conditions, beams may be switched. For example, a transmission configuration indicator (TCI) state change may be transmitted by a base station so that the UE may switch to a new beam for the TCI state. The TCI state change may cause the UE to find the best UE receive beam corresponding to the TCI state from the base station, and switch to such beam. Switching beams may allow for enhanced or improved connection between the UE and the base station by ensuring that the transmitter and receiver use the same configured set of beams for communication. A TCI state may include quasi-co-location (QCL) information that the UE can use to derive timing/frequency error and/or transmission/reception spatial filtering for transmitting/receiving a signal.

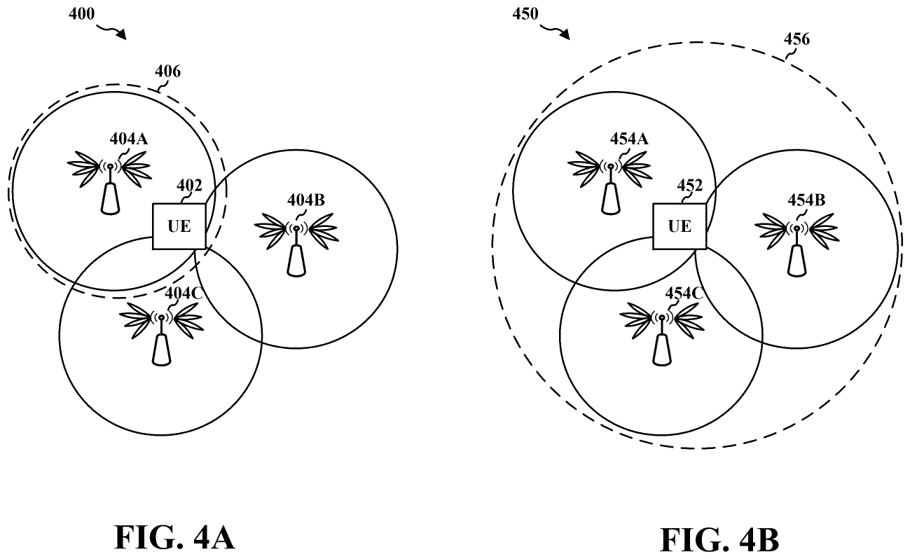

Different procedures for managing and controlling beams may be collectively referred to as “beam management.” The process of selecting a beam to switch to for data channels or control channels may be referred to as “beam selection.” In some wireless communication systems, beam selection for data channels or control channels may be limited to beams within the same physical cell identifier (ID) (PCI). A PCI may be associated with a TRP. FIG. 4A is a diagram 400 illustrating an example of beam management. As illustrated in FIG. 4A, for a UE 402, beam selection 406 may be limited to beams within the PCI 404A and beams associated with the PCI 404B and the PCI 404C may not be used. As an example, each of the PCI 404A, the PCI 404B, and the PCI 404C may be associated with a different TRP.

By way of example, a UE may encounter two types of mobility-cell-level mobility and beam-level mobility (which may be beam-based mobility). For cell-level mobility, a UE may experience an inter-base station handover. In some wireless communication systems, for beam-level mobility, as previously explained, switching of beams may occur within the same base station.

In some wireless communication systems, inter-cell beam management may be based on beam-based mobility where the indicated beam may be from a TRP with different PCI with regard to the serving cell. Benefits of inter-cell beam management based on beam-based mobility may include more robustness against blocking, more opportunities for higher rank for subscriber data management (SDM) across different cells, and in general more efficient communication between a UE and the network. FIG. 4B is a diagram 450 illustrating an example of inter-cell beam management. As illustrated in FIG. 4B, for a UE 452, beam selection 456 may be based on beams within the PCI 454A and beams associated with the PCI 454B and the PCI 454C. As an example, each of the PCI 454A, the PCI 454B, and the PCI 454C may be associated with a different TRP.

As an example, inter-cell beam management based on beam-based mobility may be facilitated by layer 1 (L1) and/or layer 2 (L2) (L1/L2) signaling, such as UE-dedicated channels/RSs, which may be associated with a switch to a TRP with different PCI according to downlink control information (DCI) or medium access control (MAC) control element (MAC-CE) based unified TCI update. As used herein, such mobility may be referred to as L1/L2 mobility (lower-layer triggered mobility (LTM)).

In some aspects, the network may configure a set of cells for L1/L2 mobility or LTM. The set of cells for L1/L2 mobility may be referred to as L1/L2 mobility configured cell set or an LTM configured cell set. A subset of the L1/L2 mobility configured cell set may be activated (e.g., with L1 or L2 control signaling) and may be referred to as an L1/L2 mobility activated cell set (which may also be referred to as an L1/L2 activated mobility cell set or LTM activated cell set). The subset of the L1/L2 mobility configured cell set that is not activated or that is indicated to be deactivated may be referred to as an L1/L2 mobility deactivated cell set or a deactivated L1/L2 mobility cell set or an LTM deactivated cell set. The L1/L2 mobility activated cell set may be a group of cells in the L1/L2 mobility configured cell set that are activated and may be readily used for data and control transfer. The L1/L2 mobility deactivated cell set (which may be an L1/L2 mobility candidate cell set) may be a group of cells in the configured set that is configured for the UE yet deactivated (e.g., not used for data/control transfer until activated) and may be activated by L1/L2 signaling. Once activated, a deactivated cell may be used for data and control transfer. The configuration and maintenance of multiple candidate cells may allow for a quicker application of configurations for the candidate cells, and the activated set of cells may provide for dynamic switching among the candidate serving cells (e.g., including a special cell (SpCell) and SCell) based on L1 or L2 signaling.

The procedures of L1/L2 based inter-cell mobility or LTM are applicable to many scenarios. These scenarios may include standalone CA and NR-DC cases with serving cell changing within one CG, intra-DU cases and intra-CU inter-DU cases (applicable for standalone and CA), intra-frequency and inter-frequency cases, FR1 and FR2 cases. In these scenarios, the source and target cells may be synchronized or non-synchronized.

For mobility management of the activated cell set, L1/L2 signaling may be used to activate/deactivate cells in the L1/L2 mobility configured cell set and to select beams within the activated cells (of the activated cell set). As the UE moves, cells from the L1/L2 mobility configured cell set may be deactivated and activated by L1/L2 signaling based on signal quality (e.g., based on measurements), loading, or the like. Example measurements may include cell coverage measurements represented by reference signal received power (RSRP), and quality represented by reference signal received quality (RSRQ), or other measurements that the UE performs on signals from the base station. In some aspects, the measurements may be L1 measurements, such as one or more of an RSRP, an RSRQ, a received signal strength indicator (RSSI), or a signal-to-interference plus noise ratio (SINR) measurement of various signals, such as an SSB, a PSS, an SSS, a broadcast channel (BCH), a DM-RS, CSI-RS, or the like.

In some aspects, all cells in the L1/L2 mobility configured cell set may belong to the same DU and the cells may be on the same or different carrier frequencies. Cells in the L1/L2 mobility configured cell set may cover a mobility area.

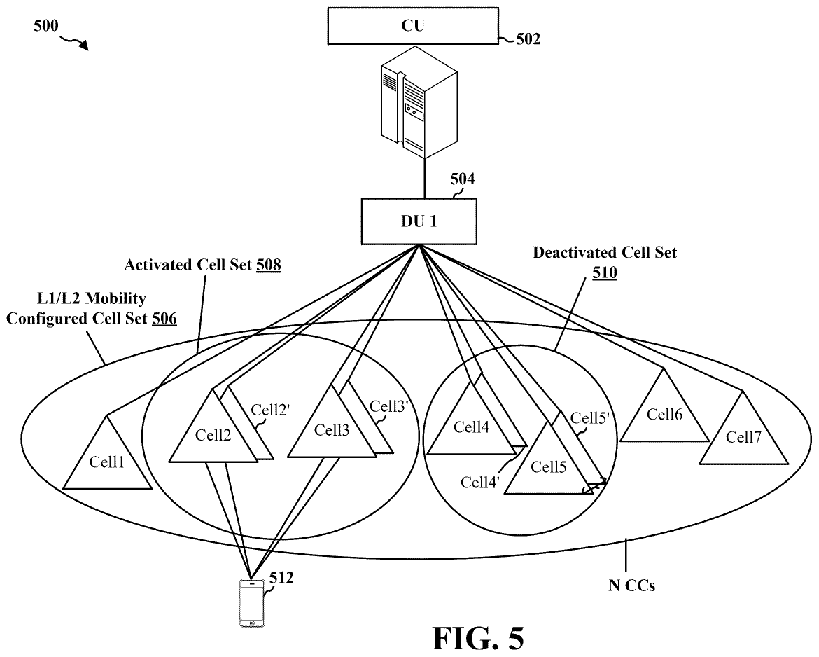

FIG. 5 is a diagram 500 illustrating an example of cell configuration. As illustrated in FIG. 5, a CU 502 (which may correspond to a component of a base station such as a gNB) may be associated with a first DU 504 (and other DUs). An L1/L2 mobility configured cell set 506 may be associated with the first DU 504 and may include an L1/L2 mobility activated cell set 508 and an L1/L2 mobility deactivated cell set 510. The L1/L2 mobility configured cell set 506 may also include one or more cells not in the current L1/L2 mobility activated cell set 508 or the current L1/L2 mobility deactivated cell set 510. For example, at a given time, the L1/L2 mobility activated cell set 508 may include a first subset of the L1/L2 mobility configured cell set, and the L1/L2 mobility deactivated cell set 510 may include a second, non-overlapping subset of the L1/L2 mobility configured cell set. There may remain one or more cells that are in the L1/L2 mobility configured cell set that are not in the first set subset (e.g., activated) or the second subset (e.g., deactivated). A UE 512 may use the cells in the L1/L2 mobility activated cell set 508 for data channel and control channel communications.

A UE may be provided with a subset of L1/L2 mobility deactivated cells (candidate cell set) that the UE may autonomously choose to add to the L1/L2 mobility activated cell set. For example, the UE may add cells in the subset of L1/L2 mobility deactivated cells to the L1/L2 mobility activated cell set based on measurements (e.g., measured channel quality), loading, or the like. In some aspects, each of the RUs could have multi-component carrier (CC) (N CCs) support (where each CC is a cell). In some aspects, activation or deactivation may be performed for groups of carriers (cells). For PCell management, L1/L2 signaling may be used to set the PCell out of the configured options within the activated cell set. In some aspects, L3 mobility may be used for PCell change (L3 handover) when a new PCell is not from the activated cell set for L1/L2 mobility. As an example, RRC signaling may be used to update the set of cells for L1/L2 mobility at L3 handover. In some aspects, L1/L2 mobility configured cells may be associated with a PCell configuration without being the PCell. The PCell configuration may be activated and one of the L1/L2 mobility activated cells (e.g., in an L1/L2 mobility activated cell set) may be activated based on L1/L2 signaling to become a PCell. In some aspects, L1/L2 mobility deactivated cells (e.g., in an L1/L2 mobility deactivated cell set) may support L1 measurements to facilitate sufficient beam management, timing synchronization, power control, or the like. For L1/L2 mobility deactivated cells, measurement reporting may be done on an activated cell.

A network node (e.g., a base station) may change an SpCell for a UE using a layer 3 (L3) handover (e.g., using radio resource control (RRC) signaling). However, L3 handovers may be time-consuming and/or inefficient. A network node that utilizes the improved L1/L2 signaling scheme is able to change one or more cells for a UE in a more rapid manner in comparison to L3 (RRC) based approaches. In an example, a UE receives an L1 or L2 mobility cell configuration for a set of cells for L1 or L2 inter-cell mobility. The set of cells may include multiple cells, and each cell in the set of cells is able to be activated or deactivated for data and/or control transfer using L1 or L2 signaling. The UE receives L1 or L2 signaling indicating multiple activated cells, and activates one or more cells in the multiple activated cells in a priority order for the data and/or control transfer using L1 or L2 signaling. Via the aforementioned L1 or L2 signaling, one or more cells, including SpCell and SCell, are able to be activated and/or deactivated in a manner that avoids RRC-based signaling. As a result, the cells may be activated and/or deactivated in a more rapid manner in comparison to RRC-based signaling. Additionally, the cells may be activated in a priority order to further facilitate more efficient and robust mobility management.

A base station may configure a UE, e.g., in RRC signaling, with a set of cells for L1/L2 mobility. The set of cells may be referred to as an L1/L2 mobility configured set. A subset of the cells in the configured set may be activated and can be used for data and control transfer between the UE and the network. The subset of activated cells may be referred to as the L1/L2 mobility activated cell set. A subset of the L1/L2 mobility configured set may be deactivated and may be referred to as the L1/L2 mobility deactivated set. The L1/L2 deactivated set of cells can be activated for the UE by L1/L2 signaling from the network.

According to the LTM procedure, a UE may move between cells associated with different network entities. Once the UE moves, the UE may perform inter-network entity handover based on one or more conditions being satisfied. Such a handover based on conditions may be referred to as “conditional handover (CHO).” For example, a UE may handover from a source cell to a target cell based on satisfaction of the one or more conditions. In some cases, an LTM procedure involving satisfaction of conditions may be referred to as a conditional LTM (C-LTM) procedure. Such a handover, in some cases, may be referred to as an “autonomous” handover. In conditional handover, a set of candidate cells (including cell ID, system information, or the like) and conditions for handover may be configured in advance via RRC. The UE may also transmit timing advance (TA) information, time alignment timer information, or other timing related information of candidate cells to enable performance of the CHO information.

A TA may be based on a length of time a signal takes to reach the network node from the UE. The UE may advance its uplink transmissions based on a value of the TA so that the uplink transmissions may align correctly with the network node's timing when it arrives at the network node (e.g., to compensate the length of time a signal takes to reach the network node from the UE). In LTM, candidate cells may be grouped into candidate cell TA groups (TAGs) (which may also be referred to as “cell-TAGs (C-TAGs)”) so that a UE may obtain a common TA for each TAG rather than individually obtaining TA information from multiple candidate cells in the TAG. In other words, rather than communicating with each candidate cell of multiple candidate cells in the TAG to obtain TA information, the UE may obtain a common TA that is applicable to all the candidate cells in the TAG. In some examples, the UE may obtain the common TA(s) via signaling from the serving cell. In some examples, the UE may use a previously indicated TA or a measured TA of a candidate cell in the C-TAG as the common TA for the TAG. The common TA for the TAG may be applied to each of the candidate cells in the TAG or, in some aspects, candidate cells in the TAG may be associated with individual TAs represented as deviations from the common TA for the TAG. For example, the signaling from the serving cell indicating the common TA for each TAG may include one or more indications of deviations from the common TA for candidate cells having different TAs than the common TA.

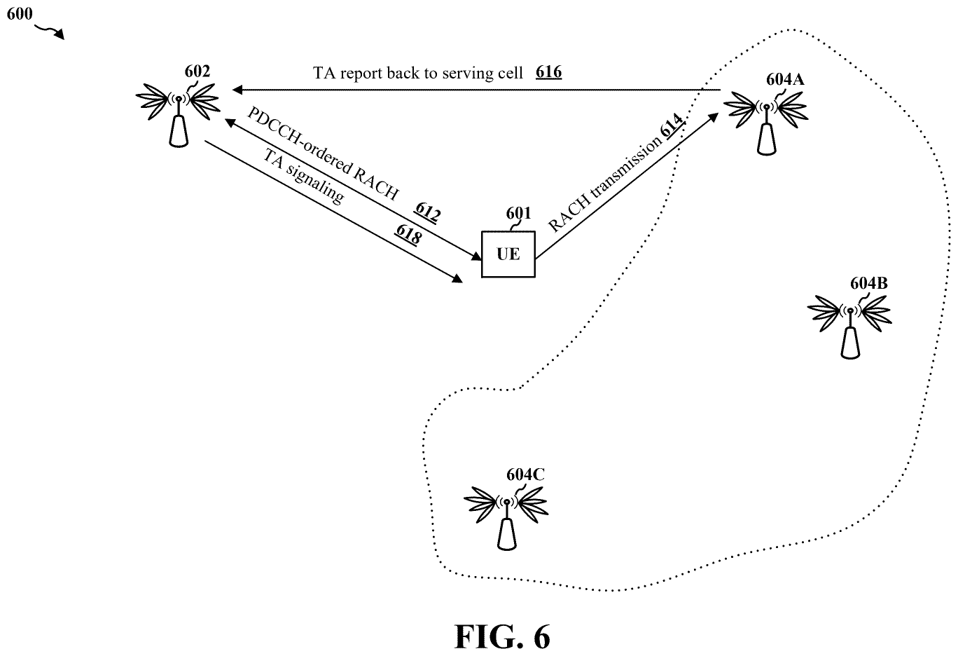

FIG. 6 is a diagram 600 illustrating an example process flow for TAGs management in conditional LTM. As illustrated in FIG. 6, the example may include a network node 602 associated with the serving cell of a UE 601, the UE 601, a candidate network node 604A, a candidate network node 604B, and a candidate network node 604C. The UE 601 may receive, from the network node 602, a command 612 for initiating PDCCH-ordered RACH with a candidate network node, such as the candidate network node 604A. Based on the command 612, the UE 601 may transmit a RACH transmission 614 to the candidate network node 604A. After receiving the RACH transmission 614 from the UE 601, the candidate network node 604A may transmit a TA 616 to the network node 602 associated with the serving cell of a UE 601, which may be a common TA for the candidate network node 604A, the candidate network node 604B, and the candidate network node 604C which belongs to a same TAG. The signaling for the TA 616 may further include a time alignment timer associated with the TA. In some aspects, after receiving the signaling for the TA 616, the network node 602 may transmit the TA 616 (e.g., and the time alignment timer) in a signaling 618 to the UE 601. The procedure for obtaining TAG configuration including the TA value or a time alignment timer may be referred to as a pre-synchronization (pre-sync) procedure.

As an example, a UE may be configured with a C-LTM configuration and at least one C-TAG configuration. The C-LTM configuration may include, by way of example, (1) conditions for triggering the LTM (e.g., based on RSRP, RSRQ, SINR, or other radio measurements values or thresholds), candidate cell information (e.g., PCIs and other information of one or more candidate cells,), execution time window (e.g., a time window in which the UE may perform the LTM after the trigger), or a mobility action type (e.g., handover, cell reselection, or the like). Each C-TAG configuration may include a time alignment timer and a TA value for the TAG. After a UE obtains TA values and starts time alignment timers for each TAG, the UE may perform C-LTM to one candidate cell and access the candidate cell via handover (e.g., RACH-less handover) based on a corresponding TA value. If the UE fails to access the candidate cell via RACH less handover based on a corresponding TA value, the UE may attempt to access a second candidate cell via RACH less handover based on a corresponding TA value associated with the second candidate cell.

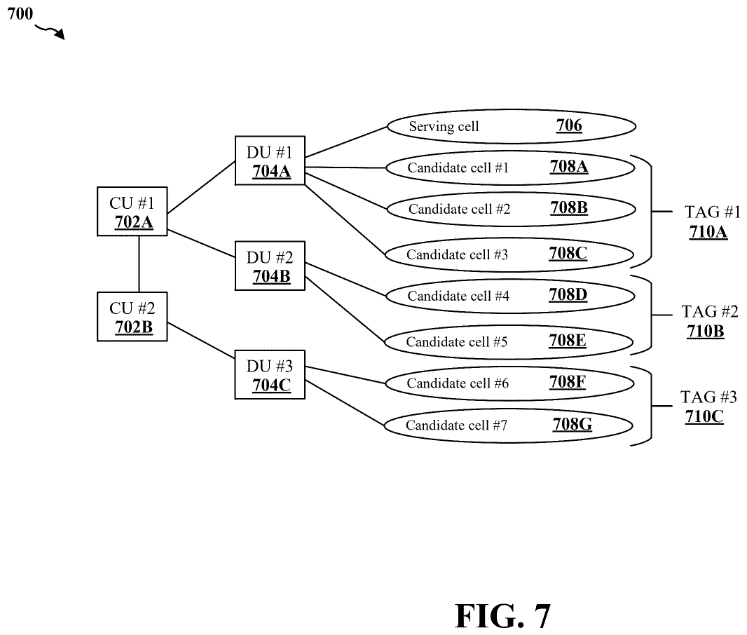

FIG. 7 is a diagram 700 illustrating example TAGs. As illustrated in FIG. 7, a first CU 702A is associated with a first DU 704A and a second DU 704B, a second CU 702B may be associated with a third DU 704C. The first DU 704A may include a serving cell 706, a first candidate cell 708A, a second candidate cell 708B, and a third candidate cell 708C. The second DU 704B may include a fourth candidate cell 708D and a fifth candidate cell 708E. The third DU 704C may include a sixth candidate cell 708F and a seventh candidate cell 708G. As an example, the first candidate cell 708A, the second candidate cell 708B, and the third candidate cell 708C may belong to a first TAG 710A. The fourth candidate cell 708D and the fifth candidate cell 708E may belong to a second TAG 710B. The sixth candidate cell 708F and the seventh candidate cell 708G may belong to a third TAG 710C.

Because candidate cells in different DU or CU may be grouped (e.g., if TRPs are deployed in the same area, if the TA value is deterministic such as zero for small cell, if the UE has an equal distance to different DUs or CUs even if the DUs or the CUs are in different areas), or the like, the TAG may be determined by one network node accordingly. Example aspects provided herein provide signaling related to scenarios where (1) the source CU determines (which may be otherwise referred to as “decide”) the TAG (e.g., and corresponding TA value or time alignment timer value), (2) the source DU determines the TAG, (3) a candidate DU determines the TAG, or (4) a candidate CU determines the TAG. As an example, candidate cells associated with different DUs may be determined by different network nodes or determined by a same network node. For example, in a first scenario where the source CU determines the TAG, the source CU may determine the TAG (e.g., and corresponding TA value or time alignment timer value) for candidate cells associated with a network node associated with the source CU or may determine the TAG for all candidate cells. In a second scenario where the source DU determines the TAG, the source DU may determine the TAG (e.g., and corresponding TA value or time alignment timer value) for candidate cells associated with a network node associated with the source DU or may determine the TAG for all candidate cells. In a third scenario where a candidate DU determines the TAG, the candidate DU may determine the TAG (e.g., and corresponding TA value or time alignment timer value) for candidate cells associated with a network node associated with the candidate DU or may determine the TAG for all candidate cells (e.g., even if there are other candidate DU(s). In a fourth scenario where a candidate CU determines the TAG, the candidate CU may determine the TAG (e.g., and corresponding TA value or time alignment timer value) for candidate cells associated with a network node associated with the candidate CU or may determine the TAG for all candidate cells. In some aspects, an example trigger to initiate the LTM procedure at the source CU may be reception of a measurement report (MR) (from a UE) that indicates (e.g., explicitly or implicitly) condition of the LTM procedure has been met, but other triggers to initiate the LTM procedure at the source CU may also be used.

Among the candidate cells, there may be “prepared candidate cells” that may be prepared (e.g., by a source network node) for LTM. There may also be “potential candidate cells” that may not be previously prepared. As used herein, the term “preparation request” may refer to a request to facilitate a C-LTM between network nodes to prepare a network node about the LTM, which may include, by way of example, UE context information associated with the UE, triggering condition or indication of previously triggered LTM, candidate cell information associated with the UE such as a list of candidate cell (e.g., in the form of PCIs), decided or recommended (which may be also referred to as “suggested”) TAG information (e.g., mapping between candidate cell(s) and TAG(s), TA value associated with each TAG, or time alignment timer value associated with each TAG) associated with at least one candidate cell (e.g., particular candidate cell(s) or all candidate cells), or RRC/PDCP/RLC configurations. In some aspects, mapping between candidate cell(s) and TAG(s) may also include cell identifier (ID) and TAG ID associated with each cell. As used herein, the term “preparation response” may refer to a response to a preparation request related to a C-LTM between network nodes, which may include candidate cell information associated with the UE such as a list of candidate cell (e.g., in the form of PCIs), TAG information (e.g., mapping between candidate cell(s) and TAG(s), TA value associated with each TAG, or time alignment timer value associated with each TAG) associated with at least one candidate cell (e.g., particular candidate cell(s) or all candidate cells), decided or recommended TAG information (e.g., mapping between candidate cell(s) and TAG(s), TA value associated with each TAG, or time alignment timer value associated with each TAG) associated with at least one candidate cell (e.g., particular candidate cell(s) or all candidate cells), or RRC/PDCP/RLC configurations. A preparation request or a preparation response may also include assistance information associated with the set of candidate cells which may facilitate decision on TAG, which may include (1) frequency information such as band (e.g., candidate cells associated with a same frequency band may be grouped into a same TAG) associated with each candidate cell, (2) RAT (e.g., candidate cells associated with a same RAT cells may be grouped into a same TAG if inter-RAT C-LTM is supported) associated with each candidate cell, (3) information of gNB, CU, DU, RU, TRPs, or network layout (e.g., candidate cells from similar/same location may be grouped into a same TAG), (4) UE information such as UE type, location (e.g., GPS basis, cell basis, tracking area basis, or the like), UE mobility history, configuration such as UL carrier aggregation (CA) with multiple TA is configured or not, UE capability, or other information related to the UE, (5) network information (e.g., network type, network congested state, or other network information associated with each candidate cell of the candidate cells), (6) recommended TAG information (e.g., mapping between candidate cell(s) and TAG(s), TA value associated with each TAG, or time alignment timer value associated with each TAG) or assistance information from other network nodes, or (7) TRP information associated with each candidate cell of the candidate cells. The assistance information may be provided by a source CU, a source DU, a candidate CU, a candidate DU, a core network (CN), operations, administration, and maintenance (OAM), a RU, or the like, to other network node(s). In some aspects, instead of or in addition to providing the assistance information in the preparation request or the preparation response, the assistance information may also be provided periodically or on an in event triggered manner (e.g., upon reception of a request message, or detection of specific message(s) on which assistance information may be piggybacked). As used herein, the term “candidate cell information” may refer to candidate cell identification information (e.g., identifiers such as PCI associated with candidate cell) and/or PRACH information associated with the candidate cell. The PRACH information may include various RACH parameters associated with the candidate cell, such as PRACH configuration index, PRACH preamble format(s), preamble index, SSB and RACH associations, RACH occasion information, or the like.

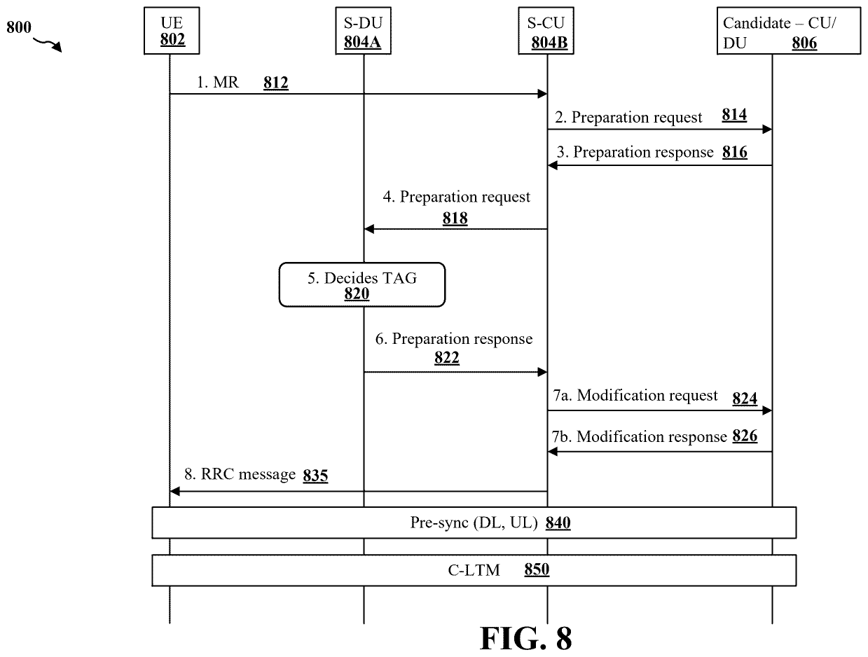

FIG. 8 is a diagram 800 illustrating example communications between source node(s) including a source CU 804B and a source DU 804A, candidate node(s) 806 (which may be a standalone network node or may include a CU and a DU), and a UE 802. As illustrated in FIG. 8, the UE 802 may transmit a MR 812 to the source CU 804B. The MR 812 may indicate (e.g., explicitly or implicitly) trigger of C-LTM. Based on receiving the MR 812, the source CU 804B may transmit a preparation request 814 to the candidate node(s) 806, and receive a preparation response 816 in response to the preparation request 814. In some aspects, as an example, the preparation request 814 may include a list of suggested candidate cells (e.g., and/or suggested candidate CUs/DUs) suggested by the source CU 804B.

In some aspects, the preparation response 816 may include lower layer configuration(s) associated with one or more candidate cells, such as one or more prepared candidate cells. In some aspects, the preparation request 814 may include candidate cell information associated with the suggested candidate cells. In some aspects, the preparation response 816 may also include suggested TAG information. In some aspects, the preparation response 816 may not include suggested TAG information. In some aspects, the source CU 804B may transmit, after receiving the preparation response 816, a preparation request 818 to the source DU 804A. In some aspects, the preparation request 818 may include candidate cell information received in the preparation response 816 and additional candidate cell information associated with the source CU 804B. In some aspects, the preparation request 818 may also include an indication to request mapping information for candidate cell(s). In some aspects, the preparation request 818 may include suggested TAG information suggested by the source CU 804B or the candidate network node(s) 806. Upon receiving the preparation request 818 from the source CU 804B, the source DU 804A may decide, at 820, the TAG information, such as mapping between candidate cell(s) and TAG(s), TA value associated with each TAG, or time alignment timer value associated with each TAG. The source DU 804A may transmit the decided TAG information in a preparation response 822 to the source CU 804B. In some aspects, the TAG information may include mapping information for candidate cell(s) of source DU and other candidate DU(s). In some aspects, the source CU 804B may transmit a modification request 824 so that the candidate network node(s) 806 may update the TAG information including mapping information, TA value, or time alignment timer value accordingly. Upon receiving the modification request 824, the candidate network node(s) 806 may transmit a modification response 826 (which may be also referred to as a “confirmation response”) as confirmation.

In some aspects, the source CU 804B may transmit the RRC message 835 to the UE 802 to provide TAG information which may include the mapping between candidate cell(s) and TAG(s), TA value associated with each TAG, or time alignment timer value associated with each TAG. The UE 802 may perform pre-synchronization 840 with the candidate cell(s) which may include monitoring the candidate cell(s) that the UE may connect to or aligning its timing based on the received TAG information. At 850, the UE 802 may perform the C-LTM procedure and may initiate assess. In some aspects, as part of 840 or 850, the UE may reset validation timer (e.g., based on the time alignment timer) associated with the TA value and may further determine an updated TA value based on measurement of reference signals associated with the candidate cell(s). Therefore, a subsequent UL communication between the UE 802 and the candidate cell may be based on the TAG information, or based on a further updated TA. In some aspects, assistance information may be provided in any preparation request or preparation response in FIG. 8.

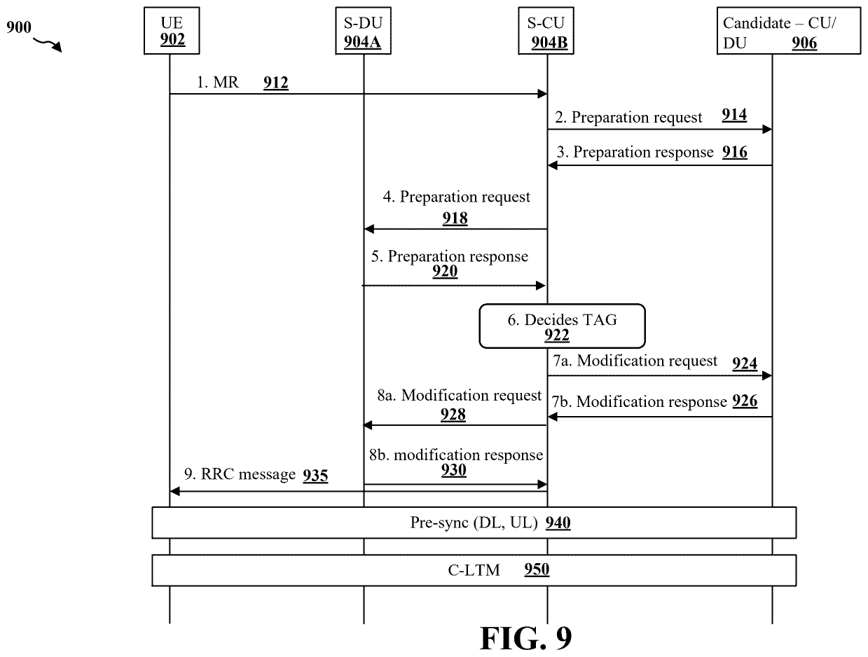

FIG. 9 is a diagram 900 illustrating example communications between source node(s) including a source CU 904B and a source DU 904A, candidate node(s) 906, and a UE 902.

As illustrated in FIG. 9, the UE 902 may transmit a MR 912 to the source CU 904B. The MR 912 may indicate (e.g., explicitly or implicitly) trigger of C-LTM. Based on receiving the MR 912, the source CU 904B may transmit a preparation request 914 to the candidate node(s) 906, and receive a preparation response 916 in response to the preparation request 914. In some aspects, as an example, the preparation request 914 may include a list of suggested candidate cells (e.g., and/or suggested candidate CUs/DUs) suggested by the source CU 904B.

In some aspects, the preparation response 916 may include lower layer configuration(s) associated with one or more candidate cells, such as one or more prepared candidate cells. In some aspects, the preparation request 914 may include candidate cell information associated with the suggested candidate cells. In some aspects, the preparation response 916 may also include suggested TAG information. In some aspects, the preparation response 916 may not include suggested TAG information. In some aspects, the source CU 904B may transmit, after receiving the preparation response 916, a preparation request 918 to the source DU 904A. In some aspects, the preparation request 918 may include candidate cell information received in the preparation response 916 and additional candidate cell information associated with the source CU 904B. In some aspects, the preparation request 918 may include suggested TAG information suggested by the source CU 904B or the candidate network node(s) 906. Upon receiving the preparation request 918 from the source CU 904B, the source DU 904A may transmit a preparation response 920 to the source CU 904B which may also include candidate cell information associated with the source DU 904A. In some aspects, the preparation response 920 may include suggested TAG information. In some aspects, the preparation response 920 may not include suggested TAG information.

Upon receiving the preparation response 920, the source CU 904B may decide, at 922, the TAG information, such as mapping between candidate cell(s) and TAG(s), TA value associated with each TAG, or time alignment timer value associated with each TAG. The source CU 904B may then transmit the decided TAG information in a modification request 924 to the candidate network node(s) 906. In some aspects, the TAG information may include mapping information for candidate cell(s) of source DU and other candidate DU(s). In some aspects, the source CU 904B may transmit a modification request 924 so that the candidate network node(s) 906 may update the TAG information including mapping information, TA value, or time alignment timer value accordingly. Upon receiving the modification request 924, the candidate network node(s) 906 may transmit a modification response 926 (which may be also referred to as a “confirmation response”) as confirmation. The source CU 904B may also transmit the decided TAG information in a modification request 928 to source DU 904A and receive a modification response 930 accordingly.

In some aspects, the source CU 904B may transmit the RRC message 935 to the UE 902 to provide TAG information which may include the mapping between candidate cell(s) and TAG(s), TA value associated with each TAG, or time alignment timer value associated with each TAG. The UE 902 may perform pre-synchronization 940 with the candidate cell(s) which may include monitoring the candidate cell(s) that the UE may connect to or aligning its timing based on the received TAG information. At 950, the UE 902 may perform the C-LTM procedure and may initiate assess. In some aspects, as part of 940 or 950, the UE may reset validation timer (e.g., based on the time alignment timer) associated with the TA value and may further determine an updated TA value based on measurement of reference signals associated with the candidate cell(s). Therefore, a subsequent UL communication between the UE 902 and the candidate cell may be based on the TAG information, or based on a further updated TA. In some aspects, assistance information may be provided in any preparation request or preparation response in FIG. 9.

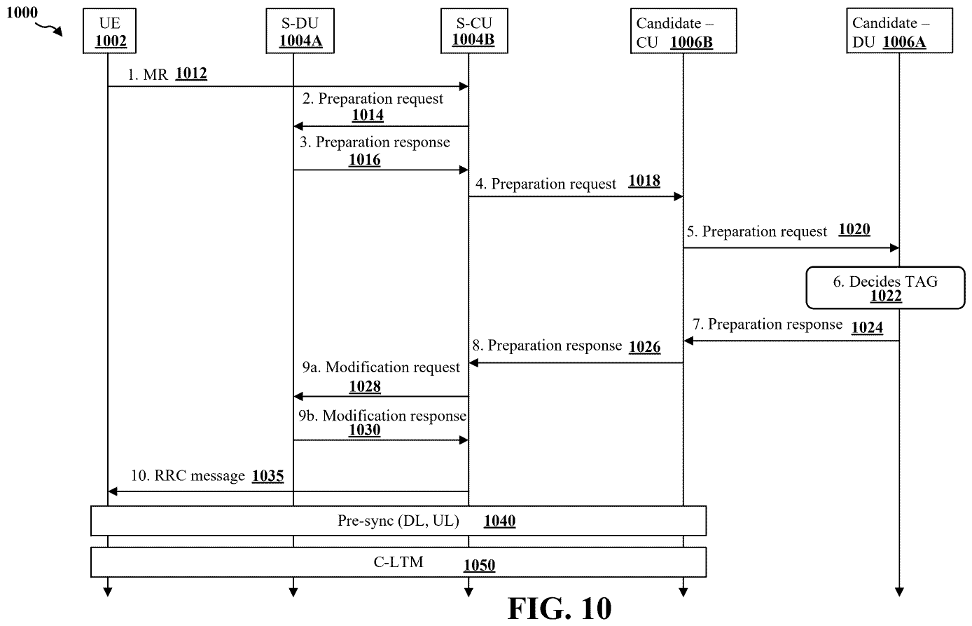

FIG. 10 is a diagram 1000 illustrating example communications between source node(s) including a source CU 1004B and a source DU 1004A, candidate node(s) including a candidate CU 1006B and a candidate DU 1006A, and a UE 1002.

In some aspects, the source CU 1004B may transmit the RRC message 1035 to the UE 1002 to provide TAG information which may include the mapping between candidate cell(s) and TAG(s), TA value associated with each TAG, or time alignment timer value associated with each TAG. The UE 1002 may perform pre-synchronization 1040 with the candidate cell(s) which may include monitoring the candidate cell(s) that the UE may connect to or aligning its timing based on the received TAG information. At 1050, the UE 1002 may perform the C-LTM procedure and may initiate assess. In some aspects, as part of 1040 or 1050, the UE may reset validation timer (e.g., based on the time alignment timer) associated with the TA value and may further determine an updated TA value based on measurement of reference signals associated with the candidate cell(s). Therefore, a subsequent UL communication between the UE 1002 and the candidate cell may be based on the TAG information, or based on a further updated TA. As illustrated in FIG. 10, the UE 1002 may transmit a MR 1012 to the source CU 1004B. The MR 1012 may indicate (e.g., explicitly or implicitly) trigger of C-LTM. Based on receiving the MR 1012, the source CU 1004B may transmit a preparation request 1014 to the source DU 1004A, and receive a preparation response 1016 in response to the preparation request 1014. In some aspects, as an example, the preparation request 1014 may include a list of suggested candidate cells (e.g., and/or suggested candidate CUs/DUs) suggested by the source CU 1004B.

In some aspects, the preparation response 1016 may include lower layer configuration(s) associated with one or more candidate cells, such as one or more prepared candidate cells. In some aspects, the preparation request 1014 may include candidate cell information associated with the suggested candidate cells. In some aspects, the preparation response 1016 may also include suggested TAG information. In some aspects, the preparation response 1016 may not include suggested TAG information. In some aspects, the source CU 1004B may also transmit a preparation request 1018 to the candidate CU 1006B. In some aspects, the preparation request 1018 may include candidate cell information received in the preparation response 1016 and additional candidate cell information associated with the source CU 1004B. In some aspects, the preparation request 1018 may also include an indication to request mapping information for candidate cell(s). In some aspects, the preparation request 1018 may include suggested TAG information suggested by the source CU 1004B or the source DU 1004A. Upon receiving the preparation request 1018 from the source CU 1004B, the candidate CU 1006B may transmit a preparation request 1020 to the candidate DU 1006A. In some aspects, the preparation request 1020 may include candidate cell information received in the preparation request 1018 and additional candidate cell information associated with the candidate CU 1006B. In some aspects, the preparation request 1020 may also include an indication to request mapping information for candidate cell(s). In some aspects, the preparation request 1020 may also include TAG information.

Upon receiving the preparation request 1020, the candidate DU 1006A may decide, at 1020, the TAG information, such as mapping between candidate cell(s) and TAG(s), TA value associated with each TAG, or time alignment timer value associated with each TAG. The candidate DU 1006A may transmit the decided TAG information in a preparation response 1024 to the candidate CU 1006B. In some aspects, the TAG information may include mapping information for candidate cell(s) of source DU and other candidate DU(s). In some aspects, the candidate CU 1006B may transmit a preparation response 1026 including the decided TAG information including mapping information, TA value, or time alignment timer value accordingly. Upon receiving the preparation response 1026, source CU 1004B may transmit a modification request 1028 to the source DU 1004A to provide the decided TAG information and receive a modification response 1030 in response.

In some aspects, the source CU 1004B may transmit the RRC message 1035 to the UE 1002 to provide TAG information which may include the mapping between candidate cell(s) and TAG(s), TA value associated with each TAG, or time alignment timer value associated with each TAG. The UE 1002 may perform pre-synchronization 1040 with the candidate cell(s) which may include monitoring the candidate cell(s) that the UE may connect to or aligning its timing based on the received TAG information. At 1050, the UE 1002 may perform the C-LTM procedure and may initiate assess. In some aspects, as part of 1040 or 1050, the UE may reset validation timer (e.g., based on the time alignment timer) associated with the TA value and may further determine an updated TA value based on measurement of reference signals associated with the candidate cell(s). Therefore, a subsequent UL communication between the UE 1002 and the candidate cell may be based on the TAG information, or based on a further updated TA. In some aspects, assistance information may be provided in any preparation request or preparation response in FIG. 10.

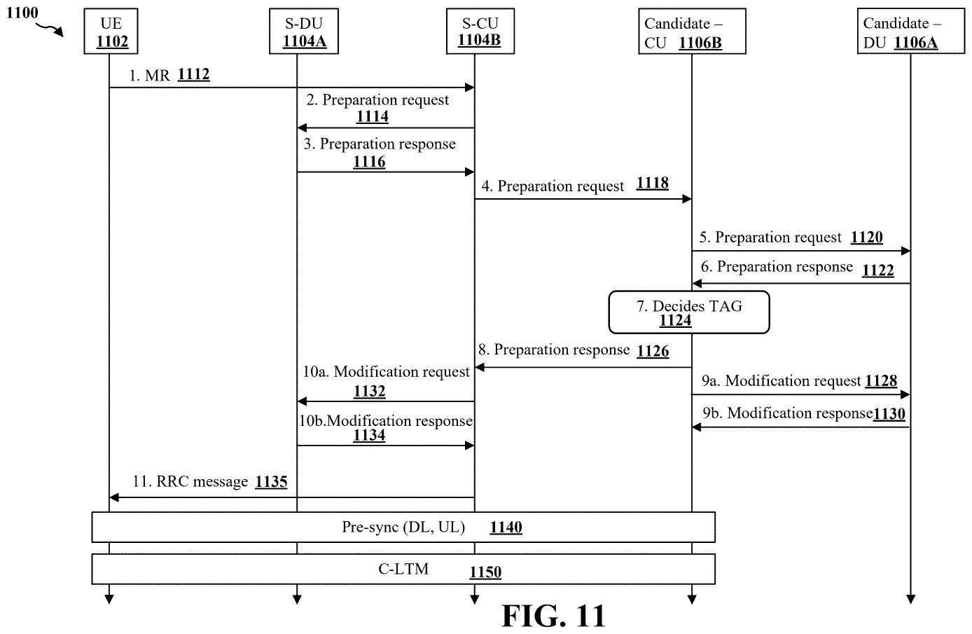

FIG. 11 is a diagram 1100 illustrating example communications between source node(s) including a source CU 1104B and a source DU 1104A, candidate node(s) including a candidate CU 1106B and a candidate DU 1106A, and a UE 1102.

As illustrated in FIG. 11, the UE 1102 may transmit a MR 1112 to the source CU 1104B. The MR 1112 may indicate (e.g., explicitly or implicitly) trigger of C-LTM. Based on receiving the MR 1112, the source CU 1104B may transmit a preparation request 1114 to the source DU 1104A, and receive a preparation response 1116 in response to the preparation request 1114. In some aspects, as an example, the preparation request 1114 may include a list of suggested candidate cells (e.g., and/or suggested candidate CUs/DUs) suggested by the source CU 1104B.

In some aspects, the preparation response 1116 may include lower layer configuration(s) associated with one or more candidate cells, such as one or more prepared candidate cells. In some aspects, the preparation request 1114 may include candidate cell information associated with the suggested candidate cells. In some aspects, the preparation response 1116 may also include suggested TAG information. In some aspects, the preparation response 1116 may not include suggested TAG information. In some aspects, the source CU 1104B may also transmit a preparation request 1118 to the candidate CU 1106B. In some aspects, the preparation request 1118 may include candidate cell information received in the preparation response 1116 and additional candidate cell information associated with the source CU 1104B. In some aspects, the preparation request 1118 may also include an indication to request mapping information for candidate cell(s). In some aspects, the preparation request 1118 may include suggested TAG information suggested by the source CU 1104B or the source DU 1104A. Upon receiving the preparation request 1118 from the source CU 1104B, the candidate CU 1106B may transmit a preparation request 1120 to the candidate DU 1106A. In some aspects, the preparation request 1120 may include candidate cell information received in the preparation request 1118 and additional candidate cell information associated with the candidate CU 1106B. In some aspects, the preparation request 1120 may also include suggested TAG information. The candidate DU 1106A may transmit a preparation response 1122 to the candidate CU 1106B, which may include lower layer configuration(s) associated with one or more candidate cells, such as one or more prepared candidate cells. In some aspects, the preparation response 1122 may also include suggested TAG information.

Upon receiving the preparation response 1122, the candidate CU 1106B may decide, at 1124, the TAG information, such as mapping between candidate cell(s) and TAG(s), TA value associated with each TAG, or time alignment timer value associated with each TAG. The candidate CU 1106B may transmit the decided TAG information in a preparation response 1126 to the source CU 1104B. In some aspects, the TAG information may include mapping information for candidate cell(s) of source DU and other candidate DU(s). In some aspects, the candidate CU 1106B may transmit a modification request 1128 including the decided TAG information including mapping information, TA value, or time alignment timer value to the candidate DU 1106A and receive a modification response 1130 in response. The source CU 1104B may forward the decided TAG information to the source DU 1104A in a modification request 1132 and receive a modification response 1134 in response. In some aspects, the source CU 1104B may transmit the RRC message 1135 to the UE 1102 to provide TAG information which may include the mapping between candidate cell(s) and TAG(s), TA value associated with each TAG, or time alignment timer value associated with each TAG. The UE 1102 may perform pre-synchronization 1140 with the candidate cell(s) which may include monitoring the candidate cell(s) that the UE may connect to or aligning its timing based on the received TAG information. At 1150, the UE 1102 may perform the C-LTM procedure and may initiate assess. In some aspects, as part of 1140 or 1150, the UE may reset validation timer (e.g., based on the time alignment timer) associated with the TA value and may further determine an updated TA value based on measurement of reference signals associated with the candidate cell(s). Therefore, a subsequent UL communication between the UE 1102 and the candidate cell may be based on the TAG information, or based on a further updated TA. In some aspects, assistance information may be provided in any preparation request or preparation response in FIG. 11.

In some aspects, a source DU may provide assistance information and the TAG information may be decided at the source CU, the candidate CU, or the candidate DU. In some aspects, a source CU may provide assistance information and the TAG information may be decided at the source DU, the candidate CU, or the candidate DU. In some aspects, a candidate DU may provide assistance information and the TAG information may be decided at the source DU, the source CU, or the candidate CU. In some aspects, a candidate CU may provide assistance information and the TAG information may be decided at the source DU, the source CU, or the candidate DU. In some aspects, if suitable mapping cannot be done, the network node may map the corresponding candidate cell to default TAG, indicate the mapping as not possible, request further assistance information, or refrain from preparing the candidate cell(s) while indicating a cause for TAG mapping failure to the candidate cell(s).

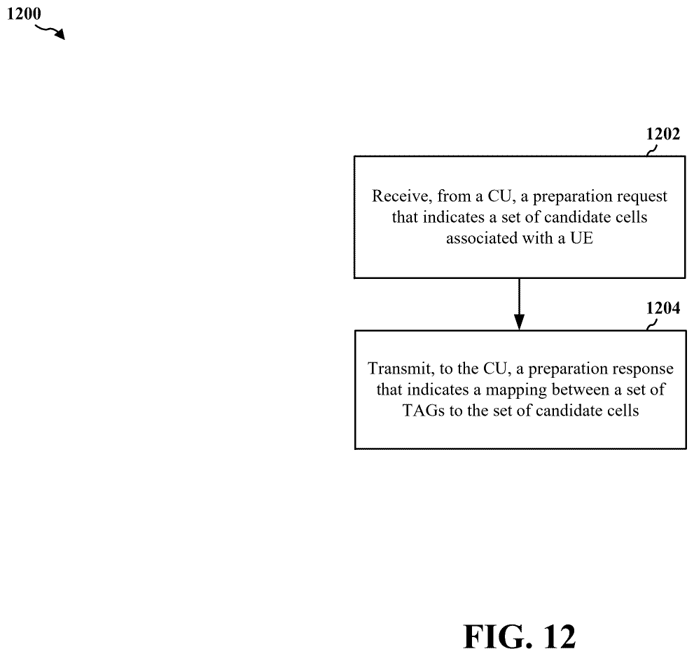

FIG. 12 is a flowchart 1200 of a method of wireless communication. The method may be performed by a DU (e.g., the base station 102, the network entity 1502, the source DU 804A, the source DU 904A, the source DU 1004A, the source DU 1104A, the candidate DU 1006A, the candidate DU 1106A, the network entity 1660).

At 1202, the DU may receive, from a CU, a preparation request that indicates a set of candidate cells associated with a UE. For example, the DU (e.g., the source DU 804A, the source DU 904A, the source DU 1004A, the source DU 1104A, the candidate DU 1006A, the candidate DU 1106A) may receive, from a CU, a preparation request (e.g., 814, 818, 914, 918, 1014, 1020, 1114, 1120) that indicates a set of candidate cells associated with a UE (e.g., the source CU 804B, the source CU 904B, the source CU 1004B, the source CU 1104B, the candidate CU 1006B, or the candidate CU 1106B). In some aspects, 1202 may be performed by TAG component 199.

At 1204, the DU may transmit, to the CU, a preparation response that indicates a mapping between a set of TAGs to the set of candidate cells. For example, the DU (e.g., the source DU 804A, the source DU 904A, the source DU 1004A, the source DU 1104A, the candidate DU 1006A, the candidate DU 1106A) may transmit, to the CU (e.g., the source CU 804B, the source CU 904B, the source CU 1004B, the source CU 1104B, the candidate CU 1006B, or the candidate CU 1106B), a preparation response (e.g., 816, 822, 916, 920, 1016, 1024, 1116, 1122) that indicates a mapping between a set of TAGs to the set of candidate cells. In some aspects, 1204 may be performed by TAG component 199.

In some aspects, the DU (e.g., 804A, 1006A) may determine (e.g., at 820, 1022) the mapping between the set of TAGs to the set of candidate cells based on assistance information associated with the set of candidate cells.

In some aspects, the assistance information is (1) generated by the DU, (2) originated from the CU, (3) originated from a second CU, or (4) originated from a second DU, and where the assistance information includes information regarding at least one of: a frequency band associated with each candidate cell of the set of candidate cells, a radio access technology (RAT) associated with each candidate cell of the set of candidate cells, a layout associated with a set of network nodes associated with the set of candidate cells, UE information associated with the UE, network information associated with each candidate cell of the set of candidate cells, transmission reception point (TRP) information associated with each candidate cell of the set of candidate cells, or a recommended mapping. In some aspects, the UE information includes at least one of: a UE type associated with the UE, a UE location associated with the UE, a UE mobility history associated with the UE, a UE capability associated with the UE, or an uplink CA configuration associated with the UE. In some aspects, the DU is a serving DU (e.g., 804A) associated with the UE. In some aspects, the DU is a candidate DU (e.g., 1006A) associated with at least one candidate cell of the set of candidate cells. In some aspects, the preparation response further includes a TA value or time alignment timer value associated with each candidate cell of the set of candidate cells.

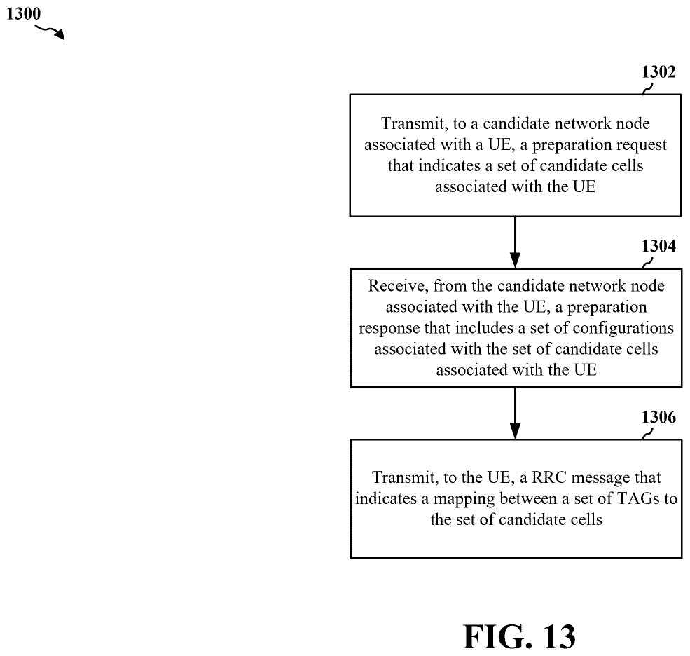

FIG. 13 is a flowchart 1300 of a method of wireless communication. The method may be performed by a source CU (e.g., the base station 102, the network entity 1502, the source CU 804B, the source CU 904B, the source CU 1004B, the source CU 1104B, the network entity 1660).

At 1302, the CU may transmit, to a candidate network node associated with a UE, a preparation request that indicates a set of candidate cells associated with the UE. For example, the CU (e.g., the source CU 804B, the source CU 904B, the source CU 1004B, the source CU 1104B) may transmit, to a candidate network node (e.g., 806, 906, 1006B, 1106B) associated with a UE (e.g., 802, 902, 1002, 1102), a preparation request (e.g., 814, 914, 1018, 1118) that indicates a set of candidate cells associated with the UE. In some aspects, 1302 may be performed by TAG component 199.

At 1304, the CU may receive, from the candidate network node associated with the UE, a preparation response that includes a set of configurations associated with the set of candidate cells associated with the UE. For example, the CU may receive, from the candidate network node associated with the UE, a preparation response (e.g., 816, 916, 1026, 1126) that includes a set of configurations associated with the set of candidate cells associated with the UE. In some aspects, 1304 may be performed by TAG component 199.

At 1306, the CU may transmit, to the UE, a RRC message that indicates a mapping between a set of TAGs to the set of candidate cells. For example, the CU may transmit, to the UE (e.g., 802, 902, 1002, 1102), a RRC message (e.g., 835, 935, 1035, 1135) that indicates a mapping between a set of TAGs to the set of candidate cells. In some aspects, 1306 may be performed by TAG component 199.

In some aspects, the CU (e.g., 804A, 1006A) may receive, from the UE (e.g., 802, 902, 1002, 1102), a MR (e.g., 812, 912, 1012, 1112) that triggers the preparation request.

In some aspects, the CU (e.g., 904B) may determine (e.g., at 922) the mapping between the set of TAGs to the set of candidate cells based on assistance information associated with the set of candidate cells.

In some aspects, the assistance information is (1) generated by the CU, (2) originated from the candidate network node, (3) originated from a second distributed unit (DU), and where the assistance information includes information regarding at least one of: a frequency band associated with each candidate cell of the set of candidate cells, a radio access technology (RAT) associated with each candidate cell of the set of candidate cells, a layout associated with a set of network nodes associated with the set of candidate cells, UE information associated with the UE, network information associated with each candidate cell of the set of candidate cells, transmission reception point (TRP) information associated with each candidate cell of the set of candidate cells, or a recommended mapping. In some aspects, the UE information includes at least one of: a UE type associated with the UE, a UE location associated with the UE, a UE mobility history associated with the UE, a UE capability associated with the UE, or an uplink CA configuration associated with the UE. In some aspects, the DU is a serving DU (e.g., 804A) associated with the UE. In some aspects, the preparation response further includes a recommendation on the mapping. In some aspects, the CU may transmit, to the candidate network node (e.g., 806, 906, 1006B, 1106B) or a DU (e.g., 804A, 904A, 1004A, 1104A) associated with the CU, a modification request (e.g., 824, 924, 928, 1028, 1128, 1132) including the mapping. In some aspects, the CU may receive a confirmation response (e.g., 826, 926, 930, 1030, 1130, 1134) for the modification request. In some aspects, the RRC message further includes a TA value or time alignment timer value associated with each candidate cell of the set of candidate cells.

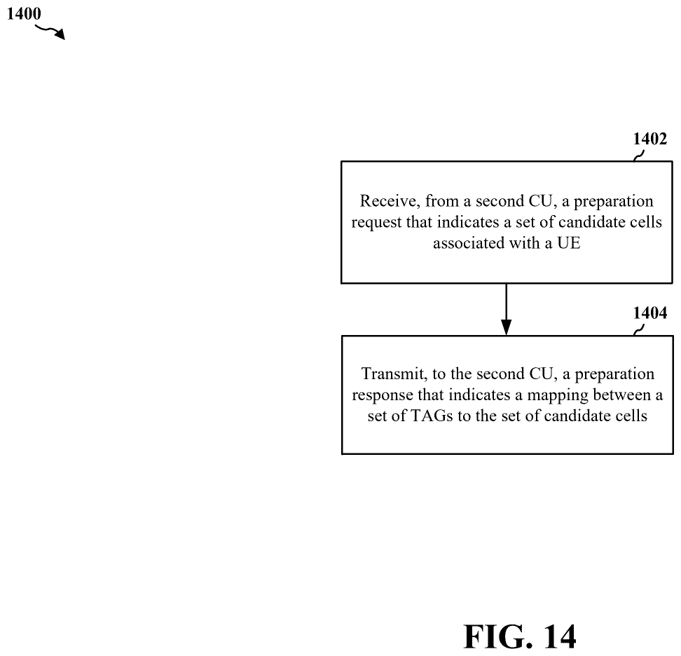

FIG. 14 is a flowchart 1400 of a method of wireless communication. The method may be performed by a candidate CU (e.g., the base station 102, the network entity 1502, the candidate CU 1006B, the candidate CU 1106B, the network entity 1660).

At 1402, the CU may receive, from a second CU, a preparation request that indicates a set of candidate cells associated with a UE. For example, the CU (e.g., 1006B, 1106B) may receive, from a second CU (e.g., 1004B, 1104B), a preparation request (e.g., 1018, 1118) that indicates a set of candidate cells associated with a UE. In some aspects, 1402 may be performed by TAG component 199.

At 1404, the CU may transmit, to the second CU, a preparation response that indicates a mapping between a set of TAGs to the set of candidate cells. For example, the CU (e.g., 1006B, 1106B) may transmit, to the second CU (e.g., 1004B, 1104B), a preparation response (e.g., 1026, 1126) that indicates a mapping between a set of TAGs to the set of candidate cells. In some aspects, 1404 may be performed by TAG component 199.

In some aspects, the CU (e.g., 1106B) may determine (e.g., at 1124) the mapping between the set of TAGs to the set of candidate cells based on assistance information associated with the set of candidate cells.

In some aspects, the assistance information is (1) generated by the CU, (2) received from a distributed unit (DU), (3) received from the second CU, or (4) received from a second DU, and where the assistance information includes information regarding at least one of: a frequency band associated with each candidate cell of the set of candidate cells, a radio access technology (RAT) associated with each candidate cell of the set of candidate cells, a layout associated with a set of network nodes associated with the set of candidate cells, UE information associated with the UE, network information associated with each candidate cell of the set of candidate cells, transmission reception point (TRP) information associated with each candidate cell of the set of candidate cells, or a recommended mapping. In some aspects, the UE information includes at least one of: a UE type associated with the UE, a UE location associated with the UE, a UE mobility history associated with the UE, a UE capability associated with the UE, or an uplink CA configuration associated with the UE. In some aspects, the CU may transmit, to the second CU or a DU (e.g., 1106A) associated with the CU, a modification request (e.g., 1128) including the mapping. In some aspects, the CU may receive a confirmation response (e.g., 1130) for the modification request. In some aspects, the preparation response further includes a TA value or time alignment timer value associated with each candidate cell of the set of candidate cells.

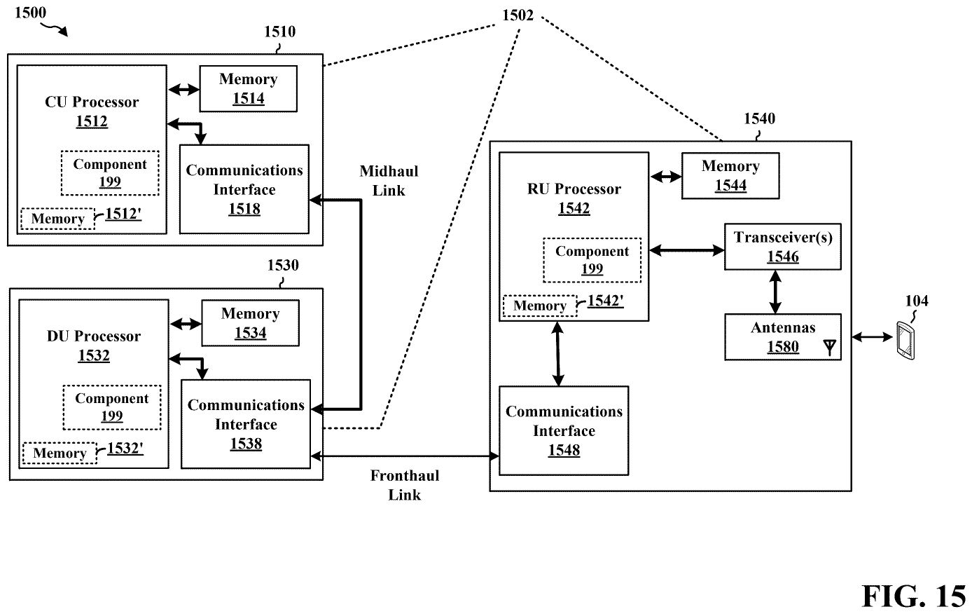

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include at least one CU processor 1512. The CU processor(s) 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include at least one DU processor 1532. The DU processor(s) 1532 may include on-chip memory 1532′. In some aspects, the DU 1530 may further include additional memory modules 1534 and a communications interface 1538. The DU 1530 communicates with the RU 1540 through a fronthaul link. The RU 1540 may include at least one RU processor 1542. The RU processor(s) 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the TAG component 199 may be configured to receive, from a CU, a preparation request that indicates a set of candidate cells associated with a UE. In some aspects, the TAG component 199 may be further configured to transmit, to the CU, a preparation response that indicates a mapping between a set of TAGs to the set of candidate cells.

In some aspects, the TAG component 199 may be further configured to transmit, to a candidate network node associated with a UE, a preparation request that indicates a set of candidate cells associated with the UE. In some aspects, the TAG component 199 may be further configured to receive, from the candidate network node associated with the UE, a preparation response that includes a set of configurations associated with the set of candidate cells associated with the UE. In some aspects, the TAG component 199 may be further configured to transmit, to the UE, a RRC message that indicates a mapping between a set of TAGs to the set of candidate cells.

In some aspects, the TAG component 199 may be further configured to receive, from a second CU, a preparation request that indicates a set of candidate cells associated with a UE. In some aspects, the TAG component 199 may be further configured to transmit, to the second CU, a preparation response that indicates a mapping between a set of TAGs to the set of candidate cells.

The TAG component 199 may be within one or more processors of one or more of the CU 1510, DU 1530, and the RU 1540. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1502 may include a variety of components configured for various functions. In one configuration, the network entity 1502 may include means for receiving, from a CU, a preparation request that indicates a set of candidate cells associated with a UE. In some aspects, the network entity 1502 may include means for transmitting, to the CU, a preparation response that indicates a mapping between a set of TAGs to the set of candidate cells. In some aspects, the network entity 1502 may include means for determining the mapping between the set of TAGs to the set of candidate cells based on assistance information associated with the set of candidate cells. In some aspects, the network entity 1502 may include means for transmitting, to a candidate network node associated with a UE, a preparation request that indicates a set of candidate cells associated with the UE. In some aspects, the network entity 1502 may include means for receiving, from the candidate network node associated with the UE, a preparation response that includes a set of configurations associated with the set of candidate cells associated with the UE. In some aspects, the network entity 1502 may include means for transmitting, to the UE, a RRC message that indicates a mapping between a set of TAGs to the set of candidate cells. In some aspects, the network entity 1502 may include means for receiving, from the UE; a measurement report (MR) that triggers the preparation request. In some aspects, the network entity 1502 may include means for transmitting, to the candidate network node or a DU associated with the CU, a modification request including the mapping. In some aspects, the network entity 1502 may include means for receiving a confirmation response for the modification request. In some aspects, the network entity 1502 may include means for receiving, from a second CU, a preparation request that indicates a set of candidate cells associated with a UE. In some aspects, the network entity 1502 may include means for transmitting, to the second CU, a preparation response that indicates a mapping between a set of TAGs to the set of candidate cells. In some aspects, the network entity 1502 may include means for transmitting, to the second CU or a DU associated with the CU, a modification request including the mapping. In some aspects, the network entity 1502 may include means for receiving a confirmation response for the modification request. The means may be the component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

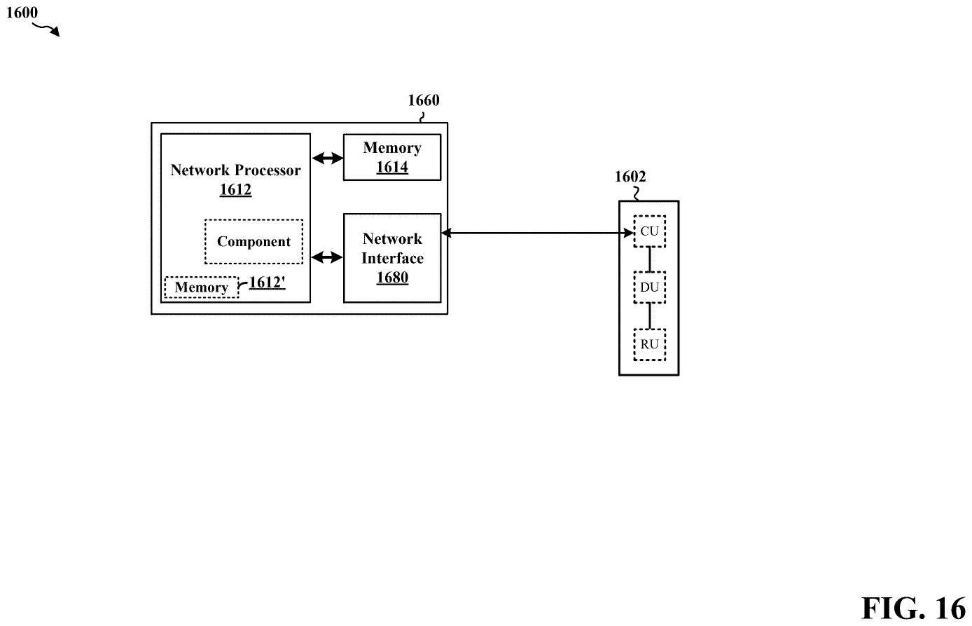

FIG. 16 is a diagram 1600 illustrating an example of a hardware implementation for a network entity 1660. In one example, the network entity 1660 may be within the core network 120. The network entity 1660 may include at least one network processor 1612. The network processor(s) 1612 may include on-chip memory 1612′. In some aspects, the network entity 1660 may further include additional memory modules 1614. The network entity 1660 communicates via the network interface 1680 directly (e.g., backhaul link) or indirectly (e.g., through a RIC) with the CU 1602. The on-chip memory 1612′ and the additional memory modules 1614 may each be considered a computer-readable medium/memory. Each computer-readable medium/memory may be non-transitory. The network processor(s) 1612 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the TAG component 199 may be configured to receive, from a CU, a preparation request that indicates a set of candidate cells associated with a UE. In some aspects, the TAG component 199 may be further configured to transmit, to the CU, a preparation response that indicates a mapping between a set of TAGs to the set of candidate cells.

In some aspects, the TAG component 199 may be further configured to transmit, to a candidate network node associated with a UE, a preparation request that indicates a set of candidate cells associated with the UE. In some aspects, the TAG component 199 may be further configured to receive, from the candidate network node associated with the UE, a preparation response that includes a set of configurations associated with the set of candidate cells associated with the UE. In some aspects, the TAG component 199 may be further configured to transmit, to the UE, a RRC message that indicates a mapping between a set of TAGs to the set of candidate cells.

In some aspects, the TAG component 199 may be further configured to receive, from a second CU, a preparation request that indicates a set of candidate cells associated with a UE. In some aspects, the TAG component 199 may be further configured to transmit, to the second CU, a preparation response that indicates a mapping between a set of TAGs to the set of candidate cells.

The component 199 may be within the network processor(s) 1612. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1660 may include a variety of components configured for various functions. In one configuration, the network entity 1660 may include means for receiving, from a CU, a preparation request that indicates a set of candidate cells associated with a UE. In some aspects, the network entity 1660 may include means for transmitting, to the CU, a preparation response that indicates a mapping between a set of TAGs to the set of candidate cells. In some aspects, the network entity 1660 may include means for determining the mapping between the set of TAGs to the set of candidate cells based on assistance information associated with the set of candidate cells. In some aspects, the network entity 1660 may include means for transmitting, to a candidate network node associated with a UE, a preparation request that indicates a set of candidate cells associated with the UE. In some aspects, the network entity 1660 may include means for receiving, from the candidate network node associated with the UE, a preparation response that includes a set of configurations associated with the set of candidate cells associated with the UE. In some aspects, the network entity 1660 may include means for transmitting, to the UE, a RRC message that indicates a mapping between a set of TAGs to the set of candidate cells. In some aspects, the network entity 1660 may include means for receiving, from the UE; a measurement report (MR) that triggers the preparation request. In some aspects, the network entity 1660 may include means for transmitting, to the candidate network node or a DU associated with the CU, a modification request including the mapping. In some aspects, the network entity 1660 may include means for receiving a confirmation response for the modification request. In some aspects, the network entity 1660 may include means for receiving, from a second CU, a preparation request that indicates a set of candidate cells associated with a UE. In some aspects, the network entity 1660 may include means for transmitting, to the second CU, a preparation response that indicates a mapping between a set of TAGs to the set of candidate cells. In some aspects, the network entity 1660 may include means for transmitting, to the second CU or a DU associated with the CU, a modification request including the mapping. In some aspects, the network entity 1660 may include means for receiving a confirmation response for the modification request. The means may be the component 199 of the network entity 1660 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a distributed unit (DU), including: at least one memory; and at least one processor coupled to the at least one memory, based at least in part on information stored in the at least one memory, the at least one processor is configured to: receive, from a central unit (CU), a preparation request that indicates a set of candidate cells associated with a user equipment (UE); and transmit, to the CU, a preparation response that indicates a mapping between a set of timing advance groups (TAGs) to the set of candidate cells.

Aspect 2 is the apparatus of aspect 1, where the at least one processor is further configured to: determine the mapping between the set of TAGs to the set of candidate cells based on assistance information associated with the set of candidate cells.

Aspect 3 is the apparatus of aspect 2, where the assistance information is (1) generated by the DU, (2) originated from the CU, (3) originated from a second CU, or (4) originated from a second DU, and where the assistance information includes information regarding at least one of: a frequency band associated with each candidate cell of the set of candidate cells, a radio access technology (RAT) associated with each candidate cell of the set of candidate cells, a layout associated with a set of network nodes associated with the set of candidate cells, UE information associated with the UE, network information associated with each candidate cell of the set of candidate cells, transmission reception point (TRP) information associated with each candidate cell of the set of candidate cells, or a recommended mapping.

Aspect 4 is the apparatus of aspect 3, where the UE information includes at least one of: a UE type associated with the UE, a UE location associated with the UE, a UE mobility history associated with the UE, a UE capability associated with the UE, or a uplink carrier aggregation (CA) configuration associated with the UE.

Aspect 5 is the apparatus of any of aspects 1-4, where the DU is a serving DU associated with the UE.

Aspect 6 is the apparatus of any of aspects 1-5, where the DU is a candidate DU associated with at least one candidate cell of the set of candidate cells.

Aspect 7 is the apparatus of any of aspects 1-6, where the preparation response further includes a timing advance (TA) value or time alignment timer value associated with each candidate cell of the set of candidate cells.

Aspect 8 is an apparatus for wireless communication at a central unit (CU), including: at least one memory; and at least one processor coupled to the at least one memory, based at least in part on information stored in the at least one memory, the at least one processor is configured to: transmit, to a candidate network node associated with a user equipment (UE), a preparation request that indicates a set of candidate cells associated with the UE; receive, from the candidate network node associated with the UE, a preparation response that includes a set of configurations associated with the set of candidate cells associated with the UE; and transmit, to the UE, a RRC message that indicates a mapping between a set of timing advance groups (TAGs) to the set of candidate cells.

Aspect 9 is the apparatus of aspect 8, where the at least one processor is further configured to: receive, from the UE; a measurement report (MR) that triggers the preparation request; determine the mapping between the set of TAGs to the set of candidate cells based on assistance information associated with the set of candidate cells.

Aspect 10 is the apparatus of aspect 9, where the assistance information is (1) generated by the CU, (2) originated from the candidate network node, (3) originated from a second distributed unit (DU), and where the assistance information includes information regarding at least one of: a frequency band associated with each candidate cell of the set of candidate cells, a radio access technology (RAT) associated with each candidate cell of the set of candidate cells, a layout associated with a set of network nodes associated with the set of candidate cells, UE information associated with the UE, network information associated with each candidate cell of the set of candidate cells, transmission reception point (TRP) information associated with each candidate cell of the set of candidate cells, or a recommended mapping.

Aspect 11 is the apparatus of aspect 10, where the UE information includes at least one of: a UE type associated with the UE, a UE location associated with the UE, a UE mobility history associated with the UE, a UE capability associated with the UE, or a uplink carrier aggregation (CA) configuration associated with the UE.

Aspect 12 is the apparatus of any of aspects 8-11, where the preparation response further includes a recommendation on the mapping.

Aspect 13 is the apparatus of any of aspects 8-12, where the at least one processor is further configured to: transmit, to the candidate network node or a distributed unit (DU) associated with the CU, a modification request including the mapping; and receive a confirmation response for the modification request.

Aspect 14 is the apparatus of any of aspects 8-13, where the RRC message further includes a timing advance (TA) value or time alignment timer value associated with each candidate cell of the set of candidate cells.

Aspect 15 is an apparatus for wireless communication at a central unit (CU), including: at least one memory; and at least one processor coupled to the at least one memory, based at least in part on information stored in the at least one memory, the at least one processor is configured to: receive, from a second CU, a preparation request that indicates a set of candidate cells associated with a user equipment (UE); and transmit, to the second CU, a preparation response that indicates a mapping between a set of timing advance groups (TAGs) to the set of candidate cells.

Aspect 16 is the apparatus of aspect 15, where the at least one processor is further configured to: determine the mapping between the set of TAGs to the set of candidate cells based on assistance information associated with the set of candidate cells.

Aspect 17 is the apparatus of aspect 16, where the assistance information is (1) generated by the CU, (2) originated from a distributed unit (DU), (3) originated from the second CU, or (4) originated from a second DU, and where the assistance information includes information regarding at least one of: a frequency band associated with each candidate cell of the set of candidate cells, a radio access technology (RAT) associated with each candidate cell of the set of candidate cells, a layout associated with a set of network nodes associated with the set of candidate cells, UE information associated with the UE, network information associated with each candidate cell of the set of candidate cells, transmission reception point (TRP) information associated with each candidate cell of the set of candidate cells, or a recommended mapping.

Aspect 18 is the apparatus of aspect 17, where the UE information includes at least one of: a UE type associated with the UE, a UE location associated with the UE, a UE mobility history associated with the UE, a UE capability associated with the UE, or an uplink carrier aggregation (CA) configuration associated with the UE.

Aspect 19 is the apparatus of any of aspects 15-18, where the at least one processor is further configured to: transmit, to the second CU or a distributed unit (DU) associated with the CU, a modification request including the mapping; and receive a confirmation response for the modification request.

Aspect 20 is the apparatus of any of aspects 15-19, where the preparation response further includes a timing advance (TA) value or time alignment timer value associated with each candidate cell of the set of candidate cells.

Aspect 21 is a method of wireless communication for implementing any of aspects 1 to 20.

Aspect 22 is a computer-readable medium (e.g., a non-transitory computer-readable medium) storing computer executable code, the code when executed by at least one processor causes the at least one processor to implement any of aspects 1 to 20.

Aspect 23 is an apparatus comprising means for implementing any of aspects 1 to 20.

What is claimed is:

1. An apparatus for wireless communication at a distributed unit (DU), comprising:
at least one memory; and
at least one processor coupled to the at least one memory, based at least in part on information stored in the at least one memory, the at least one processor is configured to:
receive, from a central unit (CU), a preparation request that indicates a set of candidate cells associated with a user equipment (UE); and
transmit, to the CU, a preparation response that indicates a mapping between a set of timing advance groups (TAGs) to the set of candidate cells.

2. The apparatus of claim 1, wherein the at least one processor is further configured to:
determine the mapping between the set of TAGs to the set of candidate cells based on assistance information associated with the set of candidate cells.

3. The apparatus of claim 2, wherein the assistance information is (1) generated by the DU, (2) originated from the CU, (3) originated from a second CU, or (4) originated from a second DU, and wherein the assistance information comprises information regarding at least one of: a frequency band associated with each candidate cell of the set of candidate cells, a radio access technology (RAT) associated with each candidate cell of the set of candidate cells, a layout associated with a set of network nodes associated with the set of candidate cells, UE information associated with the UE, network information associated with each candidate cell of the set of candidate cells, transmission reception point (TRP) information associated with each candidate cell of the set of candidate cells, or a recommended mapping.

4. The apparatus of claim 3, wherein the UE information comprises at least one of: a UE type associated with the UE, a UE location associated with the UE, a UE mobility history associated with the UE, a UE capability associated with the UE, or a uplink carrier aggregation (CA) configuration associated with the UE.

5. The apparatus of claim 1, wherein the DU is a serving DU associated with the UE.

6. The apparatus of claim 1, wherein the DU is a candidate DU associated with at least one candidate cell of the set of candidate cells.

7. The apparatus of claim 1, wherein the preparation response further includes a timing advance (TA) value or time alignment timer value associated with each candidate cell of the set of candidate cells.

8. An apparatus for wireless communication at a central unit (CU), comprising:
at least one memory; and
at least one processor coupled to the at least one memory, based at least in part on information stored in the at least one memory, the at least one processor is configured to:
transmit, to a candidate network node associated with a user equipment (UE), a preparation request that indicates a set of candidate cells associated with the UE;
receive, from the candidate network node associated with the UE, a preparation response that comprises a set of configurations associated with the set of candidate cells associated with the UE; and
transmit, to the UE, a RRC message that indicates a mapping between a set of timing advance groups (TAGs) to the set of candidate cells.

9. The apparatus of claim 8, wherein the at least one processor is further configured to:
receive, from the UE; a measurement report (MR) that triggers the preparation request; and
determine the mapping between the set of TAGs to the set of candidate cells based on assistance information associated with the set of candidate cells.

10. The apparatus of claim 9, wherein the assistance information is (1) generated by the CU, (2) originated from the candidate network node, (3) originated from a second distributed unit (DU), and wherein the assistance information comprises information regarding at least one of: a frequency band associated with each candidate cell of the set of candidate cells, a radio access technology (RAT) associated with each candidate cell of the set of candidate cells, a layout associated with a set of network nodes associated with the set of candidate cells, UE information associated with the UE, network information associated with each candidate cell of the set of candidate cells, transmission reception point (TRP) information associated with each candidate cell of the set of candidate cells, or a recommended mapping.

11. The apparatus of claim 10, wherein the UE information comprises at least one of: a UE type associated with the UE, a UE location associated with the UE, a UE mobility history associated with the UE, a UE capability associated with the UE, or a uplink carrier aggregation (CA) configuration associated with the UE.

12. The apparatus of claim 8, wherein the preparation response further comprises a recommendation on the mapping.

13. The apparatus of claim 8, wherein the at least one processor is further configured to:
transmit, to the candidate network node or a distributed unit (DU) associated with the CU, a modification request comprising the mapping; and
receive a confirmation response for the modification request.

14. The apparatus of claim 8, wherein the RRC message further includes a timing advance (TA) value or time alignment timer value associated with each candidate cell of the set of candidate cells.

15. An apparatus for wireless communication at a central unit (CU), comprising:
at least one memory; and
at least one processor coupled to the at least one memory, based at least in part on information stored in the at least one memory, the at least one processor is configured to:
receive, from a second CU, a preparation request that indicates a set of candidate cells associated with a user equipment (UE); and
transmit, to the second CU, a preparation response that indicates a mapping between a set of timing advance groups (TAGs) to the set of candidate cells.

16. The apparatus of claim 15, wherein the at least one processor is further configured to:
determine the mapping between the set of TAGs to the set of candidate cells based on assistance information associated with the set of candidate cells.

17. The apparatus of claim 16, wherein the assistance information is (1) generated by the CU, (2) originated from a distributed unit (DU), (3) originated from the second CU, or (4) originated from a second DU, and wherein the assistance information comprises information regarding at least one of: a frequency band associated with each candidate cell of the set of candidate cells, a radio access technology (RAT) associated with each candidate cell of the set of candidate cells, a layout associated with a set of network nodes associated with the set of candidate cells, UE information associated with the UE, network information associated with each candidate cell of the set of candidate cells, transmission reception point (TRP) information associated with each candidate cell of the set of candidate cells, or a recommended mapping.

18. The apparatus of claim 17, wherein the UE information comprises at least one of: a UE type associated with the UE, a UE location associated with the UE, a UE mobility history associated with the UE, a UE capability associated with the UE, or an uplink carrier aggregation (CA) configuration associated with the UE.

19. The apparatus of claim 15, wherein the at least one processor is further configured to:
transmit, to the second CU or a distributed unit (DU) associated with the CU, a modification request comprising the mapping; and
receive a confirmation response for the modification request.

20. The apparatus of claim 15, wherein the preparation response further includes a timing advance (TA) value or time alignment timer value associated with each candidate cell of the set of candidate cells.
